(19) United States
(12) Patent Application Publication
(10) Pub. No.: US 2024/0427619 A1
(43) Pub. Date: Dec. 26, 2024

(54) MAINTAINING LIVE STATE OF VIRTUAL FUNCTION DURING VIRTUAL MACHINE SAVE AND RESTORE OPERATIONS

(71) Applicant: Microsoft Technology Licensing, LLC, Redmond, WA (US)

(72) Inventor: Jie ZHOU, Kirkland, WA (US)

(73) Assignee: Microsoft Technology Licensing, LLC, Redmond, WA (US)

(21) Appl. No.: 18/340,191

(22) Filed: Jun. 23, 2023

(51) Int. Cl. G06F 9/455

(52) U.S. Cl. CPC G06F 9/45558; G06F 2009/45579; G06F 2009/45595

(57) ABSTRACT

Systems and methods are provided for maintaining a live state of a virtual function during VM fast save and fast restore operations. A computing system performs the fast save operation, by disabling network optimizations, while maintaining allocation and assignment of a VF to a VM and maintaining a VPCI bus connection between a VF device and hardware resources of a host device. The VPCI VSP is caused to save a VF device state to a runtime repository, while VF information is also saved to the runtime repository. A VM switch saves a synthetic network adapter, while a VM synthetic network adapter is torn down. The computing system subsequently performs the fast restore operation, by initializing the VM synthetic network adapter, retrieving the VF information from the runtime repository, causing creation of a VPCI bus interface, assigning the VF device, restoring the VF device state, and resuming the synthetic network adapter.

### BACKGROUND

Saving or restoring virtual machines (“VMs”) typically requires pausing and teardown of the VMs and their artifacts, followed by restoration and resumption of VM executions. Pausing, teardown, restoration, and resumption of VMs generally require time to perform, resulting in service disruptions. It is with respect to this general technical environment to which aspects of the present disclosure are directed. In addition, although relatively specific problems have been discussed, it should be understood that the examples should not be limited to solving the specific problems identified in the background or elsewhere in this disclosure.

### SUMMARY

The currently disclosed technology, among other things, provides a system, method, and apparatus for maintaining a live state of virtual functions (“VFs”) during VM save and restore operations. In examples, a host device, a network adapter, a VM synthetic network adapter, and/or other component of the host device (collectively, “computing system”) performs a modified fast save operation for a VM, followed by a modified fast restore operation for the VM. During the modified fast save operation, the computing system disables network optimizations, while maintaining allocation and assignment of a VF to the VM and maintaining a virtual peripheral component interconnect (“VPCI”) bus connection between a VF device and hardware resources of a host device. VFs, as used herein, are virtualized instances of physical network adapter(s) that can be exposed inside VMs as VF devices (e.g., VF network adapters). A VM, as used herein, refers to a virtual computer system that emulates the functionality of a physical computer. VFs enable data packets to be transmitted between the physical network adapter of a host device and the VF devices inside VMs on that host device.

During the modified fast save operation, the computing system causes a VPCI virtual service provider (“VSP”) to save a state of the VF device to a runtime repository, and also saves VF information (including an identifier (“ID”) of the VF and a locally unique identifier (“LUID”) of the VF device) to the runtime repository. The computing system then instructs a VM switch (e.g., a Hyper-VR virtual switch or extensible switch) to save and then tear down a synthetic network adapter of a network virtual service client (“NetVSC”) of the VM. During the modified fast restore operation, the computing system initializes the VM synthetic network adapter, and retrieves the VF information from the runtime repository. The computing system then causes the VPCI VSP to create a VPCI bus interface. The computing system assigns the VF device, and restores the state of the VF device based on the saved state of the VF device that is stored on the runtime repository. The computing system subsequently instructs the VM switch to resume the synthetic NIC. Herein, “synthetic network adapter” refers to a component of the NetVSC of a VM or child partition, while “VM synthetic network adapter” refers to a component of the parent partition.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example host device for maintaining a live state of a VF during VM fast save and fast restore operations.

FIG. 2 depicts an example sequence flow for implementing an example fast save operation with VF keep alive functionality.

FIG. 3 depicts an example sequence flow for implementing an example fast restore operation with VF keep alive functionality.

FIGS. 4A and 4B depict an example method for maintaining a live state of a VF during VM fast save and fast restore operations.

FIG. 5 depicts a block diagram illustrating example physical components of a computing device with which aspects of the technology may be practiced.

### DETAILED DESCRIPTION OF CERTAIN EMBODIMENTS

When a host device requires updates to one or more user mode components, virtual machines (“VMs”) associated with or running on the host device must be saved and then restored when the host update completes. As discussed above, saving and restoring VMs typically results in service disruptions due to time being required for pause, tear down, restoration, and resumption of the VMs. Updating a virtualization stack on a host device, however, should cause minimal tenant disruption. One approach is to keep alive as much of the operating environment as possible and allow flexible reloading of individual components, primarily virtualization components, rather than the entire host operating system (“OS”) (also referred to as “management OS”).

Virtual machine preserving host update (“VM-PHU”) ultra-lite (“UL”) host update technology leverages a keep alive model to perform runtime update of virtualization stack components without a host OS reboot or a kernel soft reboot. With VM-PHU UL, a hypervisor partition, virtual processors (“VPs”), and VM random access memory (“RAM”) guest physical address (“GPA”) mappings are kept alive across an operation in a manner such that VP count, RAM size, and memory backing continuity do not affect performance. Component reloadability depends on both the capabilities of an individual component to restart without a reboot, but also on active references to that component. At runtime, many components have active references, open handles, shared memory mappings, etc. After a fast save operation, a virtual machine worker process (“VMWP”) exits and tears down associated references allowing other components that no longer have active references to be stopped and serviced or runtime reloaded.

Fast save and fast restore operations of VMs or virtual devices also have costs associated with handle closure and re-opening. Costs, as used herein, refer to seconds of network blackout, resulting in service disruptions. To avoid such costs, handles can be kept alive via brokering into a separate process during VM save operations and brokering back on VM restore operations. In networking, a handle of a virtual switch or VM switch (e.g., Hyper-VR extensible switch) in a VM synthetic network adapter may be brokered to keep a state of a virtual filtering platform alive while updating user mode components to reduce tenant disruption. Handles, as used herein, refer to references or pointers to objects, such as a VM, a VM network interface card (“NIC”), a virtual device, a virtual switch, a network adapter, or a synthetic network adapter. In examples, two or more of these objects may be embodied by a single object (e.g., a VM NIC and a network adapter may be embodied as a VM synthetic network adapter).

During UL operations, a VM synthetic network adapter virtual device (“VDEV”) typically incurs a cost of a couple of seconds of network blackout while going through its VF revoking and reallocating functions during VM save and restore operations. The present disclosure provides a solution that improves efficiency while reducing or minimizing service disruptions due to general VM save and restore operations. In embodiments of the present disclosure, such solution enables the VM synthetic network adapter VDEV, as well as similar devices and VMs, to keep their VF(s) allocated and assigned by leveraging features of a VPCI to reduce the network blackout, thus reducing tenant disruption during VM save and restore (such as for VM-PHU UL save and restore operations). In particular, the VF keep alive functionality builds on network handle brokering work, which brokers a VM switch handle and restores it back from an old VMWP to a new VMWP. In other words, because a VF is tied to a VM switch handle that is opened by VM synthetic network adapter, VF keep alive functionality depends on passing the VM switch handle from the old VMWP to the new VMWP. Further, a VPCI stack supports VM-PHU UL. Any assigned physical or virtual functions do not need to be removed during the UL operation, as the guest partition and its memory remain allocated and an input/output memory management unit (“IOMMU”) remains programmed to remap direct memory access (“DMA”) requests from an assigned function to guest memory.

In some examples, the present technology provides for maintaining a live state of VFs during VM fast save and restore operations. In examples, a modified fast save operation for a VM is performed, followed by a modified fast restore operation for the VM. During the modified fast save operation, a VM synthetic network adapter disables network optimizations, while maintaining allocation and assignment of a VF to the VM and maintaining a VPCI bus connection between a VF device (e.g., VF network adapter) and hardware resources of a host device. The VF is a virtual instance of a physical network adapter that is exposed inside the VM as the VF device. The VM synthetic network adapter causes the VPCI VSP to save a state of the VF device to a runtime repository, and also saves VF information (including an identifier (“ID”) of the VF and a locally unique identifier (“LUID”) of the VF device) to the runtime repository. The VM synthetic network adapter then instructs a VM switch (e.g., extensible switch) to save the synthetic network adapter. The VM synthetic network adapter is then caused to initiate tear down. During the modified fast restore operation, the VM synthetic network adapter is initialized, and the VF information is retrieved from the runtime repository. The VM synthetic network adapter then causes the VPCI VSP to create a VPCI bus interface. The VM synthetic network adapter assigns the VF device, and restores the state of the VF device based on the saved state of the VF device that is stored on the runtime repository. The VM synthetic network adapter subsequently instructs the VM switch to resume the synthetic network adapter.

In this manner, by skipping reallocation and reassignment of the VF device, and by skipping unplugging and release of the VPCI bus, during disablement of network optimizations of a fast save operation, the VF is kept alive, and its information and state are saved in a runtime repository. During power off, the virtual bus interface may be freed, and the VM synthetic network adapter may be torn down. In the subsequent fast restore operation, by retrieving the VF information, assigning the VF device and restoring its state based on the VF information prior to resuming the VM, restoration is performed faster than conventional fast restore operations, thereby reducing or minimizing network blackouts and disruptions.

Various modifications and additions can be made to the embodiments discussed without departing from the scope of the present technology. For example, while the embodiments described above refer to particular features, the scope of the present technology also includes embodiments having different combination of features and embodiments that do not include all of the above-described features.

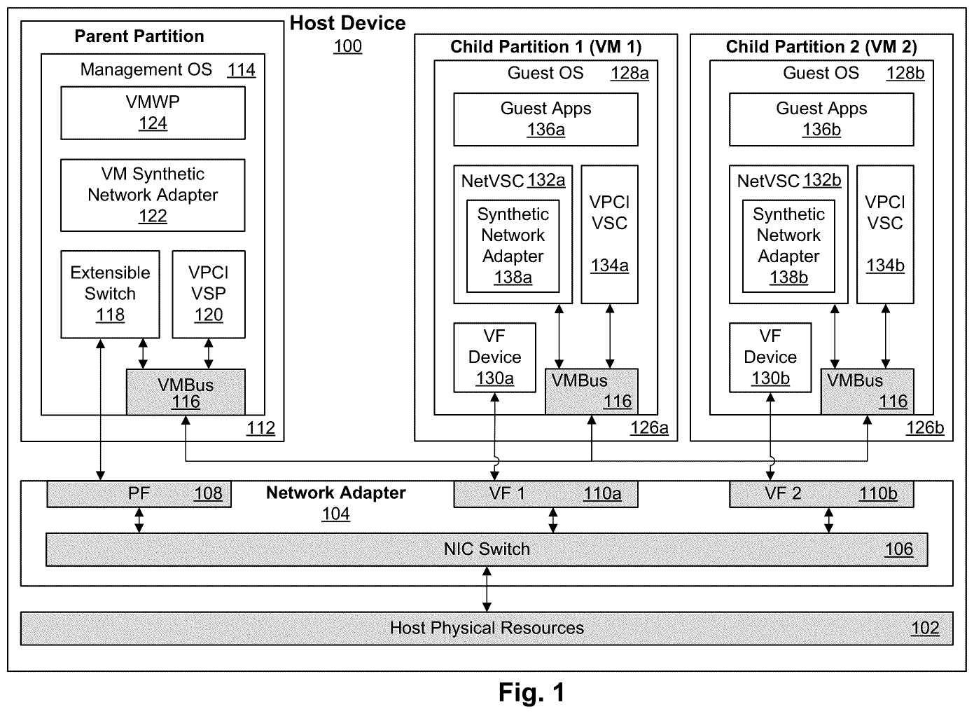

We now turn to the embodiments as illustrated by the drawings. FIGS. 1-5 illustrate some of the features of the method, system, and apparatus for implementing input/output (“I/O”) virtualization operations, and, particularly, to methods, systems, and apparatuses for maintaining a live state of a virtual function during VM fast save and fast restore operations, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

FIG. 1 depicts an example host device 100 for maintaining a live state of a VF during VM fast save and fast restore operations. Example host device 100 as presented is a combination of interdependent components that interact to form an integrated whole. Components of host device 100 may be hardware components and/or software components (e.g., applications, application programming interfaces (“APIs”), modules, VMs, or runtime libraries or repositories) implemented on and/or executed by hardware components of host device 100. In one example, components of host device 100 are distributed across multiple processing devices.

In FIG. 1, host device 100 includes host physical resources 102 and a network adapter 104. The network adapter 104 includes a network interface card (“NIC”) switch 106, a physical function (“PF”) 108, and VFs 110a and 110b (collectively, “VFs 110”). Host device 100 further includes a parent partition 112. Parent partition 112 includes management OS 114, which hosts an instance of VM bus 116, extensible switch 118, VPCI virtual service provider or virtualization service provider (“VSP”) 120, VM synthetic network adapter 122, and VMWP 124. Parent partition 112 connects with network adapter 104 via PF 108 and extensible switch 118.

Host device 100 further includes child partitions or VMs 126a and 126b (collectively, “child partitions 126” or “VMs 126”). Each VM 126 includes a guest OS 128a or 128b (collectively, “guest OSs 128”), each of which hosts an instance of VM bus or VMBus 116, VF device 130a or 130b (collectively, “VF devices 130” or “VF network adapters 130”), network virtual service client (“NetVSC”) 132a or 132b (collectively, “NetVSC 132” or “synthetic NIC”), VPCI VSC 134a or 134b (collectively, “VPCI VSC 134”), and guest applications 136a or 136b (collectively, “guest applications 136” or “guest apps 136”). In some examples, the NetVSC 132 may include synthetic network adapter 138. Although two VFs 110 and corresponding two VMs 126 are shown in FIG. 1, host device 100 may include, create (or spin up), and remove (or spin down) any suitable number of VFs 110 and corresponding VMs 126. Data traffic or data packets are passed between a VM 126 and its corresponding VF 110 to which said VM 126 is attached, via VF device 130. In examples, data packets are transferred directly between the VF device 130 and a PCI configuration space of the VF 110 on the network adapter 104. VM bus 116 is a component that provides logical communication channels among different partitions on a host device 100, as shown by inclusion of its instances in parent partition 112 and in each child partition or VM 126 as well as the arrows to and from each partition 112 or 126 to other partitions on the host device 100.

Although not shown in FIG. 1, the host device 100 may further include drivers (e.g., a PF miniport driver and VF miniport drivers) and ports (e.g., virtual ports and physical ports). A driver, as used herein, refers to a software component that enables an OS or an application to access hardware functions of a computing device without requiring the OS or application to have precise details about the hardware being used. In the context herein, miniport drivers are software components that enable the partitions (e.g., parent partition or child partitions/VMs) to access hardware or physical resources 102 of the host device 100. A port is a component that allows communications between two other components. A physical port, for example, allows one piece of hardware to communicate with another piece of hardware (e.g., allows network adapter 104 and/or a hypervisor (in this case, extensible switch 118) to communicate with host physical resources 102). A virtual port, on the other hand, allows for network communications between physical and/or virtual components using network protocols (e.g., transfer control protocol (“TCP”)/Internet Protocol (“IP”) and/or user datagram protocol (“UDP”), or other protocols). NIC switch 106 is a hardware component of the physical network adapter 104 that forwards network traffic between a physical port(s) (not shown) on the network adapter 104 and internal virtual ports (or “VPorts”; not shown) on the network adapter 104. The physical port(s) links with PF 108, while each VPort links with a corresponding VF 110.

In examples, extensible switch 118 (also referred to as “Hyper-VR extensible switch”) has network virtualization service provider functionalities. The extensible switch 118 is configured to provide network connectivity to the child partitions or VMs 126, via VM bus 116. The VPCI VSP 120 sends messages, via VM bus 116 and via VPCI VSC 134 to expose or remove VF device 130. When the extensible switch 118 creates a virtual NIC for a VM 126, the NetVSC 132 exposes that virtual NIC in VM 126 as a synthetic NIC. When a VF 110 is allocated and assigned to a VM 126, the VPCI VSC 134 exposes the VF 110 as VF device 130 (or VF network adapter 130), and a plug-and-play (“PnP”) virtualization functionality loads a VF miniport driver (not shown). NetVSC 132 is bound to this VF 110 to serve as its protocol NIC driver. The synthetic network adapter 138 provides synthetic device support via NetVSC 132, which facilitates optimized communication between the parent partition 112 and the VMs 126. A VMWP 124 is created for each VM 126, and is responsible for much of the management level interaction between the parent partition 112 and the VMs 126. The VMWP 124 handles tasks including creating, configuring, running, pausing, resuming, saving, restoring, and snapshotting its corresponding VMs 126.

Host physical resources 102 include processing hardware (e.g., a central processing unit (“CPU”), a graphics processing unit (“GPU”), and/or a video card), memory, persistent storage, a network interface, and the like. In examples, host physical resources 102 are directly accessible by management OS (or host OS) 114, VMWP 124 or other host applications, and extensible switch 118, and are not directly accessible by VM(s) 126. Instead, VM(s) 126 indirectly access host physical resources 102 via a component of host device 100, such as extensible switch 118, VM bus 116, and/or network adapter 104. In other examples, management OS 114, VMWP 124 or other host applications (e.g., VPCI VSP 120) are hosted on a parent partition (e.g., parent partition 112), and also indirectly access host physical resources 102 via the component of host device 100, such as extensible switch 118, VM bus 116, and/or network adapter 104. In some examples, VPCI VSP 120, management OS 114, and/or VMWP 124 access host physical resources 102 via NIC switch 106, PF 108, VM bus 116, and extensible switch 118. In a similar manner, each VM 126—or its guest OS 128 or guest apps 136—accesses host physical resources 102 via extensible switch 118, VPCI VSP 120, VM bus 116, VPCI VSC 134, NIC switch 106, a corresponding VF 110 (e.g., VF 110a for VM 126a, and so on), and a corresponding VF device or VF network adapter 130 (e.g., VF device or VF network adapter 130a for VF 110a and VM 126a).

Management OS 114 provides software for performing various computing functions, such as executing host applications, executing hypervisors, scheduling tasks, and controlling peripherals (e.g., microphones, touch-based sensors, geolocation sensors, accelerometers, optical/magnetic sensors, gyroscopes, keyboards, and pointing/selection tools). Management OS 114 is configured to receive input data (e.g., audio input, voice input, touch input, text-based input, gesture input, and/or image input) from a user or a computing device. In some examples, the input data corresponds to user interaction with host applications. In other examples, the input data corresponds to automated interaction with services or host applications, such as the automatic (e.g., non-manual) execution of scripts or sets of commands at scheduled times or in response to predetermined events.

Host applications may be implemented locally on host device 100 or accessible remotely by host device 100 via a network, such as a private area network (“PAN”), a local area network (“LAN”), a wide area network (“WAN”), and the like. Host applications provide access to a set of software and/or hardware functionality. Examples of host applications further include applications and services relating to word processing, spreadsheets, presentation software, document-reading, social media software or platforms, search engines, media software or platforms, multimedia players, content design software or tools, database software or tools, provisioning software, and alert or notification software.

A hypervisor is software that creates, executes, and manages VM(s) (e.g., VM(s) 126) within an execution environment of a host device (e.g., host device 100). The extensible switch 118 exposes VM(s) 126 to one or more networks in order to enable VM(s) 126 to communicate amongst each other and to communicate with other devices or components of or external to host device 100. In examples, extensible switch 118 provides VM(s) 126 access to host physical resources 102 and/or the physical resources of computing devices external to host device 100.

VMs 126 are compute resources that use software instead of a physical computing device to execute and deploy applications. Guest OSs 128 of VM(s) 126 each includes a kernel space and a user space. The kernel space is reserved for executing a privileged OS kernel, kernel extensions, and most device drivers. The user space is reserved for executing application software and non-privileged device drivers. In examples, guest OS 128 implements or has access to applications, e.g., guest apps 136, which may be as described with respect to the host applications. Each guest OS 128 may include or provide access to a different set of guest applications 136.

The scale and structure of devices, environments, and systems discussed herein may vary and may include additional or fewer components than those described in FIG. 1 and subsequent figures. Further, although examples in FIG. 1 and subsequent figures will be discussed in the context of VMs, the examples are equally applicable to other contexts, such as containers (or other virtual resources) and those contexts that do not implement virtual environments or virtual components. Examples of host device 100 include personal computers (“PCs”), server devices, mobile devices (e.g., smartphones, tablets, laptops, personal digital assistants (“PDAs”)), wearable devices (e.g., smart watches, smart eyewear, fitness trackers, smart clothing, body-mounted devices, head-mounted displays), gaming consoles or devices, and Internet of Things (“IoT”) devices.

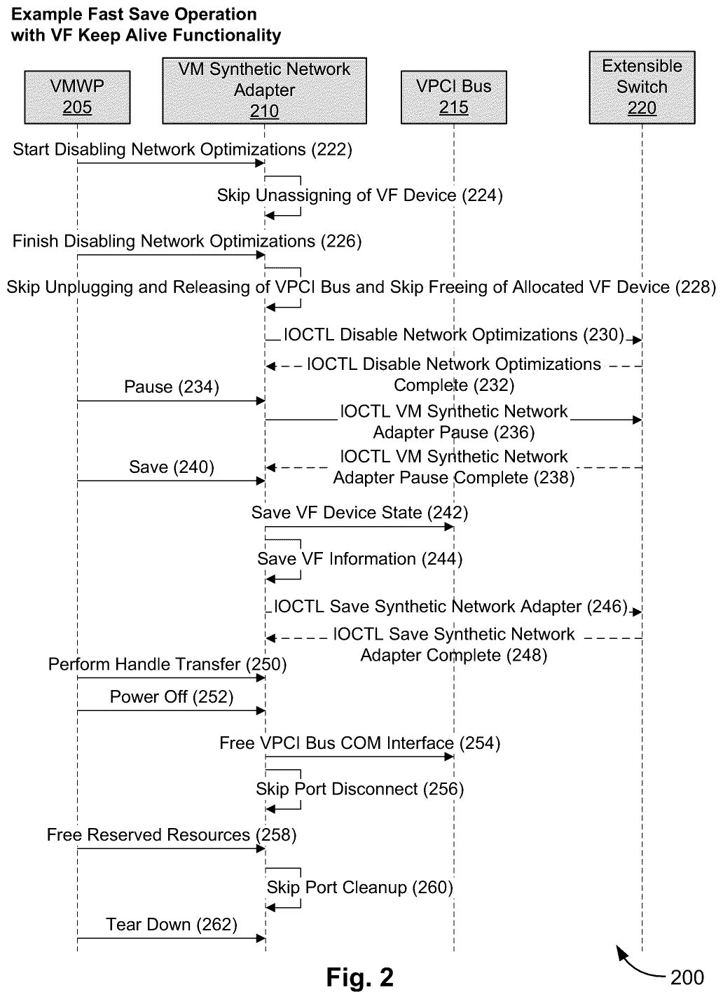

FIG. 2 depicts an example sequence flow 200 for implementing an example fast save operation with VF keep alive functionality. In the example sequence flow 200 of FIG. 2, VMWP 205, VM synthetic network adapter 210, and extensible switch 220 may be similar, if not identical, to VMWP 124, VM synthetic network adapter 122, and extensible switch 118, respectively, of host device 100 of FIG. 1. The description of these components of host device 100 of FIG. 1 are similarly applicable to the corresponding components of FIG. 2.

With reference to the example data flow 200 of FIG. 2, at operation 222, VMWP 205 calls VM synthetic network adapter 210 to start disabling network optimizations. Typically, disabling network optimizations includes revoking the VF device and freeing the VF. As part of the VF keep alive functionality, however, VM synthetic network adapter 210 skips unassigning of VF device, at operation 224. In some examples, skipping the unassigning of the VF device is triggered when it is determined by VM synthetic network adapter 210 that a flag (e.g., a VF keep alive flag or a VDEV state flag for handle transfer networking) has been set. At operation 226, VMWP 205 calls VM synthetic network adapter 210 to finish disabling network optimizations. Also as part of the VF keep alive functionality, VM synthetic network adapter 210 skips unplugging and releasing of VPCI bus 215 and skips freeing of the allocated VF device, at operation 228. In some cases, the processes at operations 222 and 226 may be combined in a single operation. In such cases, the processes at operations 224 and 228 may occur sequentially or concurrently. In some examples, VPCI bus 215 is separate from the VM bus, which provides communication channels between host VSP (e.g., VPCI VSP 120 of FIG. 1) and guest VSC (such as NetVSC 132, VPCI VSC 134, and VPCI VSP 120). In some examples, VPCI bus communications (“COM”) interface is a VPCI bus implementation mechanism.

At operation 230, VM synthetic network adapter 210 initiates an input/output control (“IOCTL”) call to extensible switch 220 to disable network optimizations. Once complete, the extensible switch 220 returns an IOCTL call result indicating that disabling network optimizations has been completed, at operation 232. At operation 234, VMWP 205 calls VM synthetic network adapter 210 to pause the VM, and VM synthetic network adapter 210 in turn initiates an IOCTL call to extensible switch 220 to pause the VM synthetic network adapter 210 (at operation 236). Once complete, the extensible switch 220 returns an IOCTL call result indicating that pause of the VM synthetic network adapter 210 has been completed, at operation 238.

At operation 240, VMWP 205 calls VM synthetic network adapter 210 to initiate save operations. In response, VM synthetic network adapter 210 calls the VPCI bus 215 to save a state of the VF device to a runtime repository (at operation 242) and saves VF information to the runtime repository (at operation 244). In some examples, if a VF is still being allocated and assigned, which may be determined if a flag (e.g., “m_IsVfAssigned” flag) is set (e.g., as “True”) indicating status of VF assignment to a VM, then the VF state and VF information are saved. The VF information, as used herein, includes an ID of the VF and a LUID of the VF device. Because unassignment and freeing allocation of the VF have been skipped (at operations 224 and 228), the flag would be set to indicate assignment of the VF. Accordingly, in such examples, calling the VPCI bus 215 to save the state of the VF device to the runtime repository (at operation 242) and saving VF information to the runtime repository (at operation 244) are performed in response to the call to initiate save operations (at operation 240) and after determining that the flag indicates assignment of the VF. At operation 246, VM synthetic network adapter 210 initiates an IOCTL call to extensible switch 220 to save the VM synthetic network adapter 210. Once complete, extensible switch 220, at operation 248, returns an IOCTL call result indicating that saving of the VM synthetic network adapter 210 has been completed. In some examples, the IOCTL call, at operation 246, causes the extensible switch 220 (e.g., VSwitch) to save state of VM synthetic network adapter 210, e.g., for future restore purposes. In the VMWP 205, objects and related resources of various types of VDEVs (e.g., storage VDEV, network VDEV, SynthNic 210) are maintained. When the VMWP 205 tears down the VDEVs, the VMWP 205 cleans up these objects and resources in VMWP namespace.

VMWP 205 calls VM synthetic network adapter 210 to perform handle transfer (at operation 250), which causes transfer of a handle of the VSwitch. At operation 252, VMWP 205 calls VM synthetic network adapter 210 to power off. Upon power off being called, the VPCI bus COM interface, which is usually freed during disabling network optimizations processes, needs to be freed. Accordingly, in response to the power off call (at operation 252), VM synthetic network adapter 210 calls VPCI bus 215 to free the VPCI bus interface, at operation 254. In some examples, it is determined whether a bus flag (e.g., “m_VpciBus” flag) has been set (e.g., is not Null), and the VPCI bus 215 is called to free the VPCI bus interface (at operation 254) in response to a determination that the bus flag has been set. At operation 256, port disconnect is skipped. At operation 258, VMWP 205 calls VM synthetic network adapter 210 to free reserved resources. VM synthetic network adapter 210, at operation 260, skips port cleanup. At operation 262, VMWP 205 calls VM synthetic network adapter 210 to tear down, resulting in VM synthetic network adapter 210 initiating its tear down. In some examples, the tear down function, at operation 262, checks whether a value of m_VpciBus is NULL or not. Normally, m_VpciBus is set to NULL at this step. However, during VF Keep Alive operations, it is skipped at this step and is instead set to NULL at power off (at operation 252).

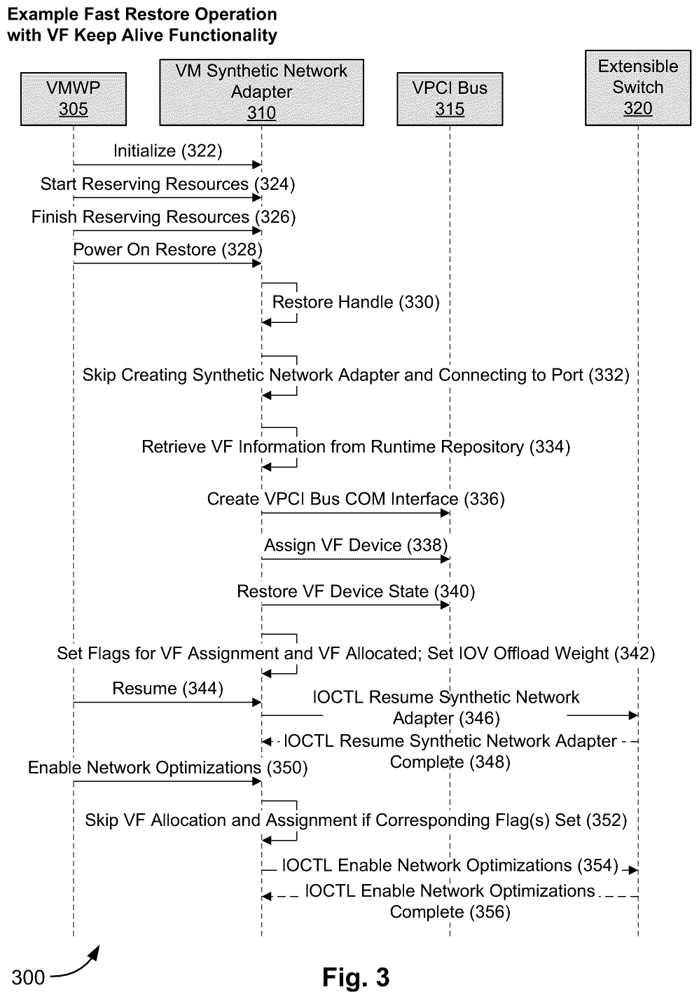

FIG. 3 depicts an example sequence flow 300 for implementing an example fast restore operation with VF keep alive functionality. In the example sequence flow 300 of FIG. 3, VMWP 305, VM synthetic network adapter 310, and extensible switch 320 may be similar, if not identical, to VMWP 124, VM synthetic network adapter 122, and extensible switch 118, respectively, of host device 100 of FIG. 1. The description of these components of host device 100 of FIG. 1 are similarly applicable to the corresponding components of FIG. 3. Similarly, VMWP 305, VM synthetic network adapter 310, VPCI bus 315, and extensible switch 320 of FIG. 3 may be similar, if not identical, to VMWP 205, VM synthetic network adapter 210, VPCI bus 215, and extensible switch 220, respectively, of FIG. 2. The description of these components of FIG. 2 are similarly applicable to the corresponding components of FIG. 3.

With reference to the example data flow 300 of FIG. 3, VMWP 305 calls VM synthetic network adapter 310 to initialize (at operation 322), to start reserving resources (at operation 324), to finish reserving resources (at operation 326), and to initiate a power-on-restore function (at operation 328). In examples, the power-on-restore function includes reading the VDEV version, reading a number of saved blocks, and reading VF information. In some cases, reading the VF information causes VM synthetic network adapter 310 to retrieve an ID of a VF associated with the VF device and an LUID of the VF device from a runtime repository.

After initializing, reserving resources, and initiating the power-on-restore function, VM synthetic network adapter 310 restores a handle of a VM switch (at operation 330), skips creating a VM synthetic network adapter and connecting to port (at operation 332), and retrieves the VF information from the runtime repository (at operation 334, as part of the power-on-restore function). In some cases, the handle of the VM switch that is restored (at operation 330) is the same handle of the VM switch that is transferred at operation 250 of FIG. 2. In examples, at operation 330, VM synthetic network adapter 310 opens a VM switch handle to invoke any APIs, by first restoring the VM switch handle. In some examples, retrieving the VF information from the runtime repository (at operation 334) is performed in response to a determination that a flag (e.g., a VF keep alive flag or a VDEV state flag for handle transfer networking) has been set. In some cases, retrieving the VF information is performed by calling a read VF information function.

In some examples, VM synthetic network adapter 310 calls VPCI bus 315 to create a VPCI bus interface (at operation 336), to assign a VF device (at operation 338), and to restore a state of the VF device (at operation 340). In an example, assigning the VF device (at operation 338) includes assigning the VF device using the VF information retrieved from the runtime repository (at operation 334). In examples, restoring the state of the VF device (at operation 340) includes restoring the state of the VF device based on a saved state of the VF device that is stored on the runtime repository (e.g., at operation 242 of FIG. 2). In some examples, restoring the state of the VF device (at operation 340) further includes setting device parameters of the VF device based on VF information including the ID of the VF and the LUID of the VF device. In examples, setting the device parameters of the VF device further includes obtaining and assigning a VM ID and/or configurating the VF device with a VPCI instance globally unique ID (“GUID”).

At operation 342, VM synthetic network adapter 310 sets a first flag (e.g., “m_IsVfAssigned” flag) indicating that the VF device has been assigned, sets a second flag (e.g., “m_AllocatedVfId” flag) indicating that the ID of the VF has been allocated, sets a value of an input/output virtualization offload weight (e.g., “m_lovOffloadWeight”) to be a non-zero value (e.g., a value of 100, or a value between 1 and 100, inclusively). In some examples, creating the VPCI bus interface (at operation 336), assigning the VF device (at operation 338), restoring the state of the VF device (at operation 340), and setting the flags and values (at operation 342) are performed in response to the determination that the flag (e.g., the VF keep alive flag or the VDEV state flag for handle transfer networking) has been set.

At operation 344, VMWP 305 calls VM synthetic network adapter 310 to resume the synthetic network adapter. In response, VM synthetic network adapter 310 initiates an IOCTL call to extensible switch 320 to resume the synthetic network adapter, at operation 346. Once complete, the extensible switch 320 returns an IOCTL call result indicating that VM resume operations have been completed, at operation 348.

At operation 350, VMWP 305 calls VM synthetic network adapter 310 to enable optimizations. At operation 352, if corresponding flag(s) (e.g., “m_IsVfAssigned” flag) has been set, VF allocation and assignment are skipped. At operation 354, VM synthetic network adapter 310 initiates an IOCTL call to extensible switch 320 to enable optimizations. Once complete, the extensible switch 320 returns an IOCTL call result indicating that enable optimization operations have been completed, at operation 356.

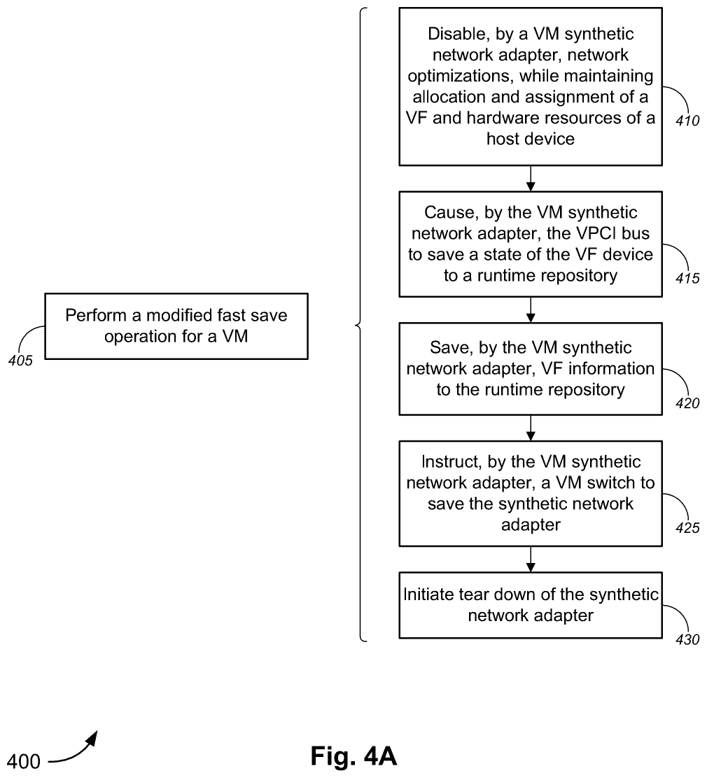

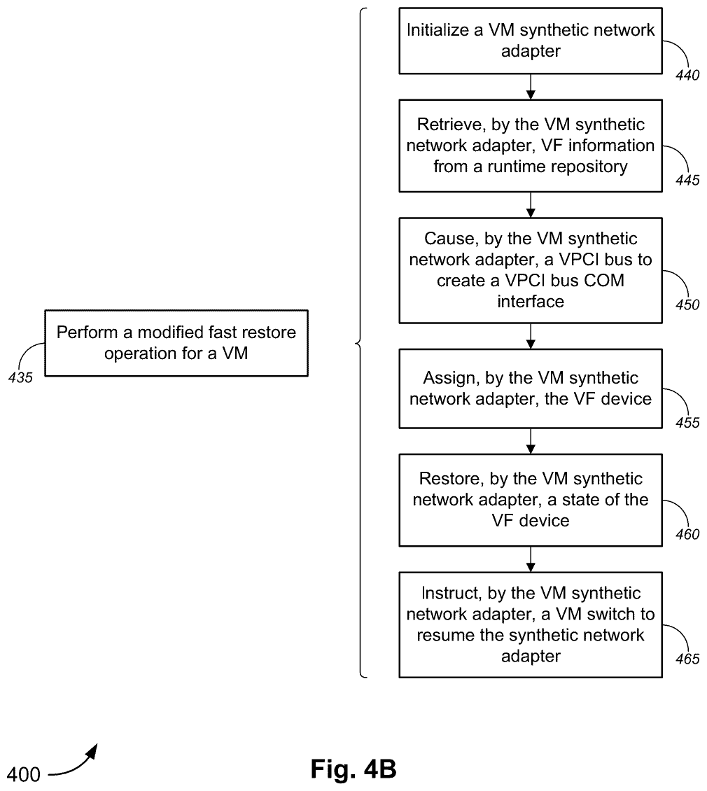

FIGS. 4A and 4B depict an example method 400 for maintaining a live state of a VF during VM fast save and fast restore operations. While the techniques and procedures are depicted and/or described in a certain order for purposes of illustration, it should be appreciated that certain procedures may be reordered and/or omitted within the scope of various embodiments. The operations of method 400 may be performed by one or more computing devices or host device components, such as the devices and components discussed in the various device and sequence flow diagrams above. In some examples, the operations of method 400 are performed by the computing device operating as the computing system or the network adapter. In FIG. 4A, operations 405-430 are directed to an example fast save operation with VF keep alive functionality, similar to the example that is shown and described above with respect to FIG. 2. In FIG. 4B, operations 435-465 are directed to an example fast restore operation with VF keep alive functionality, similar to the example that is shown and described above with respect to FIG. 3. Although not enumerated in FIG. 4A, some steps, processes, or operations described in FIG. 2 may also be applicable to method 400 of FIG. 4A. Similarly, although not enumerated in FIG. 4B, some steps, processes, or operations described in FIG. 3 may also be applicable to method 400 of FIG. 4B.

With reference to FIG. 4A, at operation 405, a computing system performs a modified fast save operation for a VM, which may include the processes at operations 410-430. At operation 410, a VM synthetic network adapter (e.g., VM synthetic network adapter 122, 210, or 310 of FIGS. 1-3) disables network optimizations, while maintaining allocation and assignment of a VF to the VM (collectively referred to as “skipping unassignment and freeing allocation of the VF”) and maintaining a VPCI bus connection between a VF device and hardware resources of a host device (referred to as “skipping unplugging and release of the VPCI bus”). The VF is a virtual instance of a physical network adapter that is exposed inside the VM as the VF device (e.g., VF network adapter). The host device may be similar to host device 100 of FIG. 1.

In an example, skipping unassignment and freeing allocation of the VF and skipping unplugging and release of the VPCI bus includes the VM synthetic network adapter instructing the VPCI VSP to skip tasks of unassigning and releasing the VF device. In another example, skipping unassignment and freeing allocation of the VF and skipping unplugging and release of the VPCI bus includes the VM synthetic network adapter skipping sending instructions to the VPCI VSP to unassign and release the VF device. In yet another example, skipping unassignment and freeing allocation of the VF and skipping unplugging and release of the VPCI bus includes the VM synthetic network adapter blocking the VPCI VSP from unassigning and releasing the VF device.

At operation 415, the VM synthetic network adapter causes the VPCI VSP to save a state of the VF device to a runtime repository. In some examples, causing the VPCI VSP to save the state of the VF device to the runtime repository includes, based on a determination that the VF remains allocated and assigned, calling, by the VM synthetic network adapter, the VPCI VSP to save the state of the VF device to the runtime repository.

At operation 420, the VM synthetic network adapter saves VF information to the runtime repository. In examples, the VF information includes an ID of the VF and a LUID of the VF device. In an example, saving the VF information includes triggering a method to write the VF information to the runtime repository. At operation 425, the VM synthetic network adapter instructs a VM switch (e.g., an extensible switch) to save the synthetic network adapter (e.g., synthetic network adapter 138 of Net VSC 132 of VM 126 of FIG. 1). At operation 430, tear down of the VM synthetic network adapter is initiated.

Referring to FIG. 4B, at operation 435, a computing system performs a modified fast restore operation for a VM, which may include the processes at operations 440-465. At operation 440, a VM synthetic network adapter, or an instance of a VM synthetic network adapter, is initialized. At operation 445, the VM synthetic network adapter retrieves VF information from a runtime repository (e.g., the VF information that is saved to the runtime repository at operation 420 of FIG. 4A). As described above, the VF includes an ID of a VF and a LUID of a VF.

At operation 450, the VM synthetic network adapter causes the VPCI bus to create a VPCI bus interface, in some cases, using a call to perform such operation.

At operation 455, the VM synthetic network adapter assigns the VF device. In examples, assigning the VF device includes the VM synthetic network adapter assigning the VF device using the VF information (including the ID of the VF and the LUID of the VF device) that is retrieved from the runtime repository (at operation 445). In some examples, after the VF device has been assigned using the ID of the VF and the LUID of the VF device, a connection is established between the VF device and hardware resources of a host device (e.g., host device 100 of FIG. 1).

At operation 460, the VM synthetic network adapter restores a state of the VF device. In some examples, restoring the state of the VF device includes the VM synthetic network adapter calling the VPCI VSP to restore the state of the VF device based on a saved state of the VF device that is stored on the runtime repository. In an example, restoring the state of the VF device further includes setting device parameters of the VF device based on VF information including the ID of the VF and the LUID of the VF device.

In some embodiments, retrieving the VF information (e.g., the ID of the VF and the LUID of the VF device; at operation 445), assigning the VF device (at operation 455), and restoring the state of the VF device (at operation 460) are performed by implementing a retrieve-and-restore-virtual-function function. At operation 465, the VM synthetic network adapter instructs a VM switch (e.g., the same VM switch that is instructed to save the synthetic network adapter at operation 425) to resume the synthetic network adapter.

While the method 400 illustrated by FIGS. 4A and 4B can be implemented by or with (and, in some cases, are described above with respect to) the systems, examples, or embodiments 100, 200, and 300 of FIGS. 1, 2, and 3, respectively (or components thereof), such methods may also be implemented using any suitable hardware (or software) implementation. Similarly, while each of the systems, examples, or embodiments 100, 200, and 300 of FIGS. 1, 2, and 3, respectively (or components thereof), can operate according to the method 400 illustrated by FIGS. 4A and 4B (e.g., by executing instructions embodied on a computer readable medium), the systems, examples, or embodiments 100, 200, and 300 of FIGS. 1, 2, and 3 can each also operate according to other modes of operation and/or perform other suitable procedures.

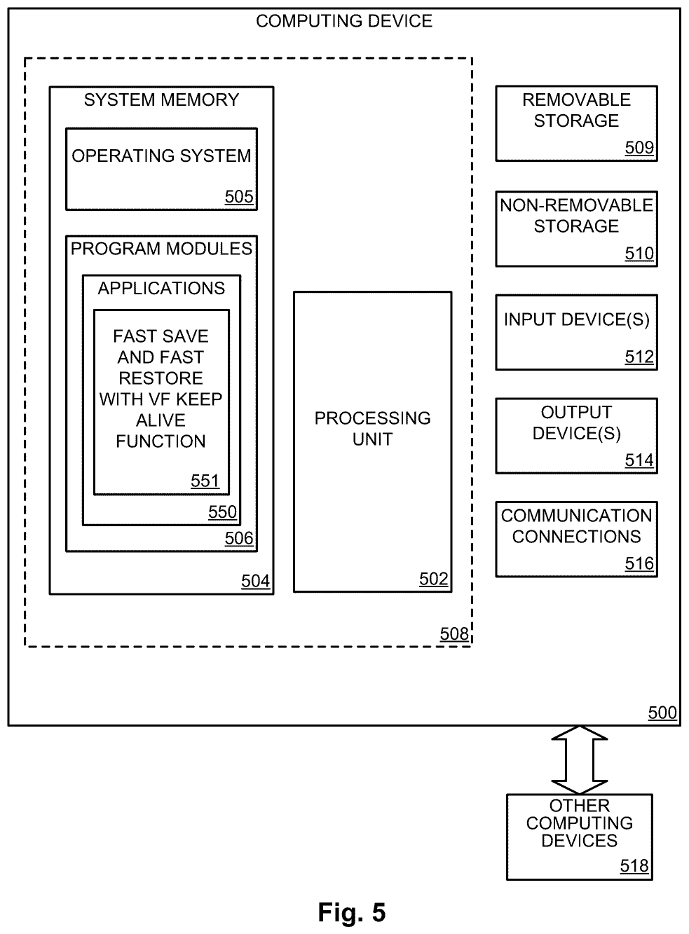

FIG. 5 depicts a block diagram illustrating physical components (i.e., hardware) of a computing device 500 with which examples of the present disclosure may be practiced. The computing device components described below may be suitable for a host device or its components maintaining a live state of a VF during VM fast save and fast restore operations, as discussed above. In a basic configuration, the computing device 500 includes at least one processing unit 502 and a system memory 504. The processing unit(s) (e.g., processors) may be referred to as a processing system. Depending on the configuration and type of computing device, the system memory 504 may include volatile storage (e.g., random access memory), non-volatile storage (e.g., read-only memory), flash memory, or any combination of such memories. The system memory 504 may include an operating system 505 and one or more program modules 506 suitable for running software applications 550, such as VM fast save and fast restore with VF keep alive functionality 551, to implement one or more of the systems or methods described above.

The operating system 505, for example, may be suitable for controlling the operation of the computing device 500. Furthermore, aspects of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionalities. For example, the computing device 500 may also include additional data storage devices (which may be removable and/or non-removable), such as, for example, magnetic disks, optical disks, or tape. Such additional storage is illustrated in FIG. 5 by a removable storage device(s) 509 and a non-removable storage device(s) 510.

As stated above, a number of program modules and data files may be stored in the system memory 504. While executing on the processing unit(s) 502, the program modules 506 may perform processes including one or more of the operations of the method(s) as illustrated in FIGS. 4A and 4B, or one or more operations of the system(s) and/or apparatus(es) as described with respect to FIGS. 1-3, or the like. Other program modules that may be used in accordance with examples of the present invention may include applications such as electronic mail and contacts applications, word processing applications, spreadsheet applications, database applications, slide presentation applications, drawing or computer-aided application programs, AI applications and machine learning (“ML”) modules on cloud-based systems, etc.

Furthermore, examples of the present disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 5 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 500 on the single integrated circuit (or chip). Examples of the present disclosure may also be practiced using other technologies capable of performing logical operations such as, for example, AND, OR, and NOT, including mechanical, optical, fluidic, and/or quantum technologies.

The computing device 500 may also have one or more input devices 512 such as a keyboard, a mouse, a pen, a sound input device, and/or a touch input device, etc. The output device(s) 514 such as a display, speakers, and/or a printer, etc. may also be included. The aforementioned devices are examples and others may be used. The computing device 500 may include one or more communication connections 516 allowing communications with other computing devices 518. Examples of suitable communication connections 516 include radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 504, the removable storage device 509, and the non-removable storage device 510 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture that can be used to store information and that can be accessed by the computing device 500. Any such computer storage media may be part of the computing device 500. Computer storage media may be non-transitory and tangible, and computer storage media does not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, communication media may include wired media such as a wired network or direct-wired connection, and wireless media such as acoustic, RF, infrared, and other wireless media.

In an aspect, the technology relates to a system. The system includes a processing system and memory coupled to the processing system. The memory includes computer executable instructions that, when executed by the processing system, causes the system to perform a modified fast save operation for a virtual machine (“VM”). The modified fast save operation includes disabling network optimizations, while maintaining allocation and assignment of a virtual function (“VF”) to the VM and maintaining a virtual peripheral component interconnect (“VPCI”) bus connection between a VF device and hardware resources of a host device. The VF is a virtual instance of a physical network adapter that is exposed inside the VM as the VF device. The modified fast save operation further includes causing the VPCI virtual service provider (“VSP”) to save a state of the VF device to a runtime repository; saving an identifier (“ID”) of the VF and a locally unique identifier (“LUID”) of the VF device to the runtime repository; and instructing a VM switch to save the synthetic network adapter.

In some examples, causing the VPCI VSP to maintain allocation and assignment of the VF device to the VM and to maintain the VPCI bus connection includes performing one of: instructing the VPCI VSP to skip tasks of unassigning and releasing the VF device; skipping sending instructions to the VPCI VSP to unassign and release the VF device; or blocking the VPCI VSP from unassigning and releasing the VF device.

In examples, the modified fast save operation further includes determining whether the VF device remains allocated and assigned. In some examples, causing the VPCI VSP to save the state of the VF device to the runtime repository includes, based on a determination that the VF device remains allocated and assigned, calling the VPCI VSP to save the device state of the VF to the runtime repository.

In some examples, saving the ID of the VF and the LUID of the VF device to the runtime repository includes triggering a method to write VF information including the ID of the VF and the LUID of the VF device to the runtime repository. In some cases, the modified fast save operation further includes, after saving the VM, based on a determination that a VPCI bus interface remains active, freeing the VPCI bus interface. In some instances, the VPCI bus interface is an interface through which the VPCI bus connection is established. In some cases, freeing the VPCI bus interface includes calling the VPCI VSP to reset the VPCI bus interface. In some examples, the modified fast save operation further includes tearing down a VM synthetic network adapter.

In another aspect, the technology relates to a system. The system includes a processing system and memory coupled to the processing system. The memory includes computer executable instructions that, when executed by the processing system, causes the system to perform a modified fast restore operation for a virtual machine (“VM”). The modified fast restore operation includes retrieving an identifier (“ID”) of a virtual function (“VF”) and a locally unique identifier (“LUID”) of a VF device from a runtime repository. The VF is a virtual instance of a physical network adapter that is exposed inside the VM as the VF device. The modified fast restore operation further includes causing a virtual peripheral component interconnect (“VPCI”) virtual service provider (“VSP”) to create a VPCI bus interface; assigning the VF device; restoring a state of the VF device; and instructing a VM switch to resume the synthetic network adapter.

In some examples, the modified fast restore operation further includes, prior to retrieving the ID of the VF and the LUID of the VF device, initializing a VM synthetic network adapter, reserving resources, and initiating a power-on-restore function. In examples, initiating the power-on-restore function includes reading a virtual device (“VDEV”) version, reading a number of saved blocks, and reading virtual function information. In some cases, reading the virtual function information causes the VM synthetic network adapter to retrieve the ID of the VF and the LUID of the VF device from the runtime repository.

In examples, causing the VPCI VSP to create the VPCI bus interface includes calling the VPCI VSP to create the VPCI bus interface. In some cases, assigning the VF device includes assigning the VF device using the ID of the VF and the LUID of the VF device retrieved from the runtime repository. In some instances, creating the VPCI bus interface includes, after the VF device has been assigned using the ID of the VF and the LUID of the VF device, establishing a connection between the VF device and hardware resources of a host device.

In some examples, restoring the state of the VF device includes calling the VPCI VSP to restore the state of the VF device based on a saved state of the VF device that is stored on the runtime repository. In some cases, restoring the state of the VF device further includes setting device parameters of the VF device based on VF information including the ID of the VF and the LUID of the VF device. In examples, the modified fast restore operation further includes at least one of: setting a first flag indicating that the VF device has been assigned; setting a second flag indicating that the ID of the VF has been allocated; or setting a value of an input/output virtualization offload weight to be a non-zero value.

In examples, retrieving the ID of the VF and the LUID of the VF device, assigning the VF device, and restoring the state of the VF device are performed by implementing a retrieve-and-restore-virtual-function function. In some examples, the modified fast restore operation further includes, after resuming the VM, based on a determination that the VF device has been assigned, causing the VPCI VSP to skip creation of the VPCI bus interface, allocation of the VF, and assignment of the VF device.

In yet another aspect, the technology relates to a computer-implemented method. The method includes a computing system performing operations including performing a modified fast save operation for a virtual machine (“VM”) and performing a modified fast restore operation for the VM. In examples, performing the modified fast save operation includes disabling network optimizations, while maintaining allocation and assignment of a virtual function (“VF”) to the VM and maintaining a virtual peripheral component interconnect (“VPCI”) bus connection between a VF device and hardware resources of a host device. The VF is a virtual instance of a physical network adapter that is exposed inside the VM as the VF device. Performing the modified fast save operation further includes causing a VPCI virtual service provider (“VSP”) to save a state of the VF device to a runtime repository; saving an identifier (“ID”) of the VF and a locally unique identifier (“LUID”) of the VF device to the runtime repository; instructing a VM switch to save the synthetic network adapter; and initiating tear down of a VM synthetic network adapter.

In some examples, performing the modified fast restore operation includes initializing the VM synthetic network adapter; retrieving the ID of the VF and the LUID of the VF device from the runtime repository; causing the VPCI VSP to create a VPCI bus interface; assigning the VF device; restoring the state of the VF device based on the saved state of the VF device that is stored on the runtime repository; and instructing the VM switch to resume the synthetic network adapter. In examples, the computing system includes the VM synthetic network adapter.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. For denoting a plurality of components, the suffixes “a” through “n” may be used, where n denotes any suitable integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A system, comprising:
a processing system; and
memory coupled to the processing system, the memory comprising computer executable instructions that, when executed by the processing system, causes the system to perform a modified fast save operation for a virtual machine (“VM”), the modified fast save operation comprising:
disabling network optimizations, while maintaining allocation and assignment of a virtual function (“VF”) to the VM and maintaining a virtual peripheral component interconnect (“VPCI”) bus connection between a VF device and hardware resources of a host device, wherein the VF is a virtual instance of a physical network adapter that is exposed inside the VM as the VF device;
causing the VPCI virtual service provider (“VSP”) to save a state of the VF device to a runtime repository;
saving an identifier (“ID”) of the VF and a locally unique identifier (“LUID”) of the VF device to the runtime repository; and
instructing a VM switch to save the synthetic network adapter.

2. The system of claim 1, wherein causing the VPCI VSP to maintain allocation and assignment of the VF device to the VM and to maintain the VPCI bus connection comprises performing one of:
instructing the VPCI VSP to skip tasks of unassigning and releasing the VF device;
skipping sending instructions to the VPCI VSP to unassign and release the VF device; or
blocking the VPCI VSP from unassigning and releasing the VF device.

3. The system of claim 1, wherein the modified fast save operation further comprises:
determining whether the VF device remains allocated and assigned.

4. The system of claim 3, wherein causing the VPCI VSP to save the state of the VF device to the runtime repository comprises:
based on a determination that the VF device remains allocated and assigned, calling the VPCI VSP to save the device state of the VF to the runtime repository.

5. The system of claim 1, wherein saving the ID of the VF and the LUID of the VF device to the runtime repository comprises:
triggering a method to write VF information including the ID of the VF and the LUID of the VF device to the runtime repository.

6. The system of claim 1, wherein the modified fast save operation further comprises:
after saving the VM, based on a determination that a VPCI bus interface remains active, freeing the VPCI bus interface, wherein the VPCI bus interface is an interface through which the VPCI bus connection is established.

7. The system of claim 6, wherein freeing the VPCI bus interface comprises calling the VPCI VSP to reset the VPCI bus interface.

8. The system of claim 1, wherein the modified fast save operation further comprises:
tearing down a VM synthetic network adapter.

9. A system, comprising:
a processing system; and
memory coupled to the processing system, the memory comprising computer executable instructions that, when executed by the processing system, causes the system to perform a modified fast restore operation for a virtual machine (“VM”), the modified fast restore operation comprising:
retrieving an identifier (“ID”) of a virtual function (“VF”) and a locally unique identifier (“LUID”) of a VF device from a runtime repository, wherein the VF is a virtual instance of a physical network adapter that is exposed inside the VM as the VF device;
causing a virtual peripheral component interconnect (“VPCI”) virtual service provider (“VSP”) to create a VPCI bus interface;
assigning the VF device;
restoring a state of the VF device; and
instructing a VM switch to resume the synthetic network adapter.

10. The system of claim 9, wherein the modified fast restore operation further comprises:
prior to retrieving the ID of the VF and the LUID of the VF device, initializing a VM synthetic network adapter, reserving resources, and initiating a power-on-restore function;
wherein initiating the power-on-restore function comprises reading a virtual device (“VDEV”) version, reading a number of saved blocks, and reading virtual function information, wherein reading the virtual function information causes the VM synthetic network adapter to retrieve the ID of the VF and the LUID of the VF device from the runtime repository.

11. The system of claim 9, wherein causing the VPCI VSP to create the VPCI bus interface comprises:
calling the VPCI VSP to create the VPCI bus interface.

12. The system of claim 9, wherein assigning the VF device comprises:
assigning the VF device using the ID of the VF and the LUID of the VF device retrieved from the runtime repository.

13. The system of claim 9, wherein creating the VPCI bus interface comprises:
after the VF device has been assigned using the ID of the VF and the LUID of the VF device, establishing a connection between the VF device and hardware resources of a host device.

14. The system of claim 9, wherein restoring the state of the VF device comprises:
calling the VPCI VSP to restore the state of the VF device based on a saved state of the VF device that is stored on the runtime repository.

15. The system of claim 14, wherein restoring the state of the VF device further comprises:
setting device parameters of the VF device based on VF information including the ID of the VF and the LUID of the VF device.

16. The system of claim 9, wherein the modified fast restore operation further comprises at least one of:
setting a first flag indicating that the VF device has been assigned;
setting a second flag indicating that the ID of the VF has been allocated; or
setting a value of an input/output virtualization offload weight to be a non-zero value.

17. The system of claim 9, wherein retrieving the ID of the VF and the LUID of the VF device, assigning the VF device, and restoring the state of the VF device are performed by implementing a retrieve-and-restore-virtual-function function.

18. The system of claim 9, wherein the modified fast restore operation further comprises:
after resuming the VM, based on a determination that the VF device has been assigned, causing the VPCI VSP to skip creation of the VPCI bus interface, allocation of the VF, and assignment of the VF device.

19. A computer-implemented method, comprising a computing system performing operations comprising:
performing a modified fast save operation for a virtual machine (“VM”), by:
disabling network optimizations, while maintaining allocation and assignment of a virtual function (“VF”) to the VM and maintaining a virtual peripheral component interconnect (“VPCI”) bus connection between a VF device and hardware resources of a host device, wherein the VF is a virtual instance of a physical network adapter that is exposed inside the VM as the VF device;
causing a VPCI virtual service provider (“VSP”) to save a state of the VF device to a runtime repository;
saving an identifier (“ID”) of the VF and a locally unique identifier (“LUID”) of the VF device to the runtime repository;
instructing a VM switch to save the synthetic network adapter; and
initiating tear down of a VM synthetic network adapter; and
performing a modified fast restore operation for the VM, by:
initializing the VM synthetic network adapter;
retrieving the ID of the VF and the LUID of the VF device from the runtime repository;
causing the VPCI VSP to create a VPCI bus interface;
assigning the VF device;
restoring the state of the VF device based on the saved state of the VF device that is stored on the runtime repository; and
instructing the VM switch to resume the synthetic network adapter.

20. The computer-implemented method of claim 19, wherein the computing system comprises the VM synthetic network adapter.
